(19) United States
(12) Patent Application Publication
(10) Pub. No.: US 2008/0124187 A1
(43) Pub. Date: May 29, 2008

(54) Self-drilling, self-tapping screw fasteners

(76) Inventor: Harry M. Haytayan, Nashua, NH (US)

Correspondence Address: Nicholas A. Pandiscio;Pandiscio & Pandiscio, P.C., 470 Totten Pond Road, Waltham, MA, 02451-1914, US

(21) Appl. No.: 11/594,595

(22) Filed: Nov. 8, 2006

(51) Int. Cl. F16B 25/10; F16B 15/08; B65D 85/24

(52) U.S. Cl. 411/387.1; 411/442; 206/346

(57) ABSTRACT

A clip of fasteners for use in attaching a structural panel to a metal substrate comprises a plastic strip with openings characterized by inwardly-extending ribs for gripping and supporting fasteners that comprise a forward self-drilling portion and a rearward self-tapping thread portion. Each fastener has a head with a top surface adapted for driving engagement by a driver tool for rotatively driving the fastener, and a tapered surface having a plurality of circumferentially spaced cutting edges that function to (a) cut away the ribs supporting the fastener as the fastener is rotatively driven through the structural panel to secure the panel to the substrate and (b) also create a countersink in the structural panel. The cutting edges are formed by provided a plurality of first and second alternately-occurring relief sections in the tapered surface of the, with the cutting edges extending at an acute angle to said shank in a first direction and also in a second direction.

### FIELD OF THE INVENTION

The present invention generally relates to attaching structural elements with fasteners, and more particularly to an improved screw fastener for use in fastening structural elements together.

### BACKGROUND OF THE INVENTION

It is well known to use screws for securing floor, wall and ceiling panels to supporting structures in buildings, vehicle cargo container bodies, mobile homes and other personnel or cargo containing structures. In the case of cargo container bodies, e.g., truck trailer bodies, hard wood floors are attached to a metal frame or substrate. The typical truck trailer body has a steel frame, and the hardwood flooring is secured to the steel frame with metal fasteners. One common technology for securing floors to truck trailer bodies requires pre-drilling holes in both the wood flooring and the underlying metal frame, e.g., steel angle irons or junior 1-beams, and using a powered screwdriver to drive to apply self-tapping screws through the pre-drilled holes to anchor the flooring to the frame. In an attempt to avoid the necessity of pre-drilling the underlying frame members, driver/fastening systems have been conceived that utilize special high carbon steel self-drilling, self-tapping screws and a high torque rotary screwdriver. However, for the most part, those systems function satisfactorily only if the underlying metal to be penetrated is a mild steel, e.g., 33 ksi yield steel, and has a maximum thickness of about 3/16″ or less. A further impedance to use of self-drilling screws is that currently trailer body manufacturers are preferring to use a high tensile strength steel having a tensile strength of 80,000 psi and a yield strength of approximately 50,000-65,000 psi, with the steel substrate typically being a ⅛ inch thick junior I-beam. The use of self-drilling screws was a problem due to difficulty in reliably penetrating the high strength steel because of the screws tending to burn due to the heat buildup. Hence for the most part the preferred practice was to pre-drill holes in the hard wood and the high strength ⅛ inch thick junior I-beam, and then screw self-tapping hardened screws into those holes via a powered screw-driver to secure the flooring to the substrate. However, this two-step process was unsatisfactory since drilling the hardwood flooring and the underlying high tensile strength steel is time-consuming and also costly because the expensive drills used to penetrate the high strength substrate tend to burn out prematurely due to heat buildup. Therefore, there existed a need for an improved fastening method and screw driving apparatus which can reliably attach hard wood flooring to high tensile strength steel substrates having a thickness in the order of ⅛″ or thicker. That need was met by the method and apparatus described and illustrated in my U.S. Pat. No. 6,990,731, issued Jan. 31, 2006 for “Method And Apparatus For Attaching Structural Components” (that patent is incorporated herein by reference).

The screw driving tool described in my U.S. Pat. No. 6,990,731 comprises a rotary impact driver and includes a magazine for slidably supporting a relatively stiff plastic strip that has a plurality of openings each characterized by a number of radially-extending retainer ribs that grip a self-drilling, self-tapping screw, each of which has a tapered head with cutting ribs on its underside as described and claimed in my U.S. Pat. No. 6,676,353, issued Jan. 13, 2004 for “Self-Drilling, Self-Tapping Screws” (that patent is incorporated herein by reference). Those cutting ribs, which have a rectangular cross-sectional shape, are intended to cut through the surrounding plastic strip as it is driven. Those same cutting ribs also are intended to cut into the hard wood flooring member as the fastener is screwed in place to secure the flooring member to a steel substrate, whereby to produce a tapered recess (countersink) to accommodate the tapered screw head and thereby permitting the screw to be driven in far enough for its head to be flush with or below, e.g., about ⅛ inch below, the top surface of the flooring member.

It has been determined that a limitation of the screw fasteners disclosed in my above-identified U.S. Pat. No. 6,676,353 is that sometimes the cutting ribs on the screw head have difficulty in cutting the hard wood flooring to provide a countersink (recess), tending to burnish rather that cut the flooring and impeding the effort to drive the fastener so that its head is at least flush with the upper surface of the flooring. That problem was most apparent with larger diameter screws as are required for certain truck body applications. It is preferred to use a relatively stiff plastic strip for supporting the fasteners. However, the stiffer the plastic, the longer it takes for the rectangular cutting ribs on the screw heads to cut away the plastic retainer ribs that hold the screws in the plastic strip.

### OBJECTS AND SUMMARY OF THE INVENTION

Accordingly the primary object of the invention is to provide a screw fastener for attaching hard wood flooring members to metal substrates that overcomes the limitations of the screw fastener described and illustrated in my U.S. Pat. No. 6,676,353.

Another object is to provide a self-drilling, self-tapping screw fastener having a tapered head characterized by unique cutting edges for cutting through hard wood flooring and paneling.

A further object is to provide a clip of fasteners for use with a powered screw driver apparatus, the clip comprising a plastic fastener-retaining strip adapted to be supported by and move along a fastener magazine or holder into fastener-driving position relative to a driver associated with the magazine, and a plurality of self-drilling, self-tapping screws supported by the plastic strip, with the screws having tapered heads with unique cutting edges that facilitate (a) removal of the screws from the plastic strip when being driven into fastening relation with structural components and (b) countersinking the tapered heads in structural members that are fastened in place by the screws.

These and other objects are achieved by providing a plurality of screw fasteners that are formed so as to have a shank comprising a first self-drilling portion and a second self-tapping screw portion contiguous with the first drilling portion, and a head contiguous with said screw portion that is adapted to be rotatively driven by a torque driver. The head of each fastener is characterized by a plurality of angular cutting edges with each edge being formed and defined by alternately-occurring first relief surfaces that extend at a first angle and second relief surfaces that intersect said first relief surfaces at a selected angle, preferably an angle of approximately 90 degrees. In the preferred embodiment of the invention, each cutting edge has a first bottom end that intersects said shank and a second top end that is displaced in a circumferential direction from said first bottom end. The fasteners are mounted in plastic strips so that they may be inserted in a magazine of a screw driver apparatus, e.g., a rotary impact driver as disclosed in my U.S. Pat. No. 6,990,731. The same fastener-carrying strips may be used with other non-impact screw driver apparatus having a fastener-holding magazine similar to the one disclosed in my U.S. Pat. No. 6,990,731. The improved screw fasteners also may be used with screw drivers having screw feeding magazines that do not require the fasteners to be mounted in a supporting plastic strip, and also may be used in individual fashion with powered screw drivers that do not have a feeder magazine for successively feeding a series of fasteners into driving position. Other features, properties and advantages of the fasteners embodying the present invention are described or rendered obvious by the following detailed specification and the accompanying drawings.

### THE DRAWINGS

FIG. 1 is a side view in elevation of a screw fastener embodying the present invention;

FIG. 2 is a top end view of the head of the fastener;

FIG. 3 is a cross-sectional view taken along lines 3-3 of FIG. 1;

FIG. 4 is an enlarged fragmentary side elevation of the tip of the screw fastener;

FIG. 5 is an enlarged fragmentary side elevation of the head of the same fastener;

FIG. 6 is a front end view of the same screw fastener;

FIG. 7 is a perspective view showing a portion of a clip consisting of a plurality of the same fasteners supported by a plastic strip;

FIG. 8 is a longitudinal center line sectional view of the clip shown in FIG. 7, with the fasteners shown in side elevation; and

FIG. 9 is another perspective view of the same clip.

### DETAILED DESCRIPTION

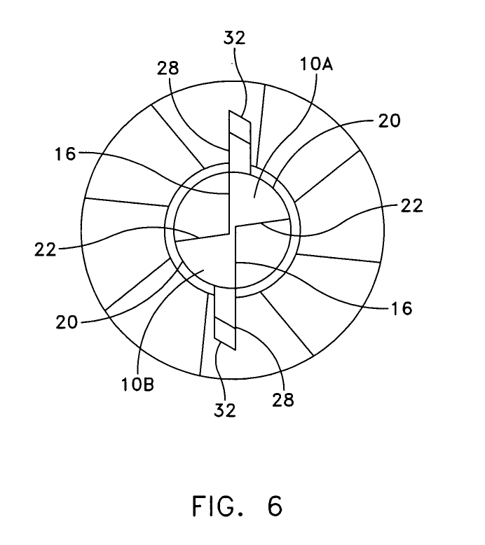

Referring to FIGS. 1-8, the illustrated self-tapping, self-drilling fastener is made of a high carbon steel and is surface hardened by carburizing its surface to a depth of between 0.005 inch and 0.010 inch to a hardness in the range of 55-60 Rockwell. The screw fastener comprises a shank or shaft 4 and a head 6. Shaft 4 comprises a forward self-drilling portion that comprises two helical cutting flutes 10A and 10B (FIG. 6) and a rearward screw portion that is characterized by a screw thread 12. The two cutting flutes are in diametrically-opposed relation to one another and have forward edges that define a tapered tip 14 which has an apex angle in the range of about 120° to about 140°; preferably about 130° to about 135°, so as to facilitate piercing steel or other metal as hereinafter described. Flutes 10A and 10B extend backwards for a predetermined distance from tip 14. One side of each flute has a flat surface 16 that extends radially and terminates in a sharp longitudinal cutting edge 18 (FIG. 1). Each flute also is characterized by a circularly curved side surface 20 that intersects its flat surface 16 and is interrupted by a beveled surface 22 that intersects the flat surface 16 of the other flute along a tapered line that extends from tip 14 back to thread 12. Beveled surface 22 also intersects at least the leading turn of screw thread 12 whereby to facilitate initiation of a self-tapping action by the screw thread when it encounters a steel or other metal substrate. Cutting flutes 10A and 10B enable the forward portion of shaft 4 to function as a drill, with the drill being rotated counter-clockwise as viewed in FIG. 6.

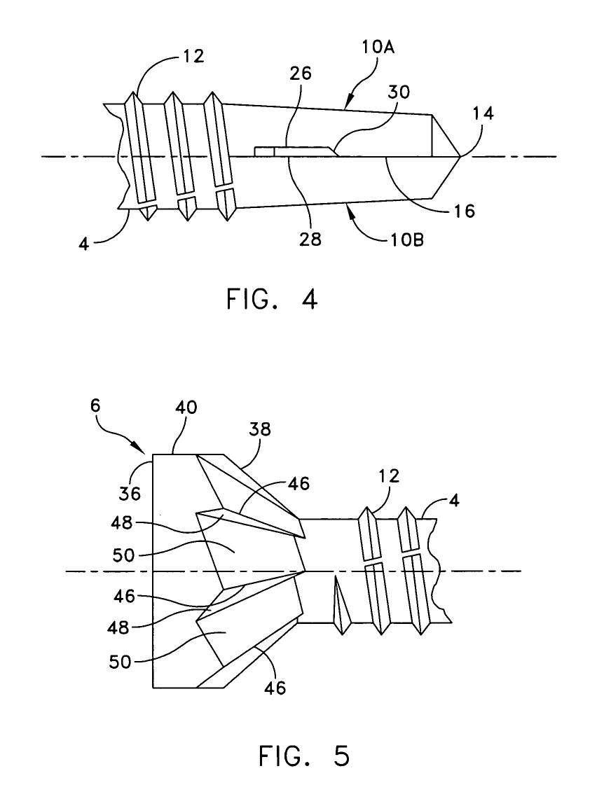

Formed integral with the rearward portions of flutes 10A and 10b are two diametrically opposed radially-protruding blade-like cutting wings 26 characterized by flat side surfaces 28 (FIG. 6) that are extensions of side surfaces 16 of the cutting flutes. The forward end edge of each wing, i.e., the end edge that is closest to tip 14, is beveled (as shown in 30 FIG. 4) so as to provide a sharp cutting edge. Preferably the longitudinal edges of side surfaces 28 of wings 26 also are beveled (as shown at 32 in FIG. 6) so as provide an elongate cutting edge. Wings 26 are sized so as to enlarge the hole formed in the hard wood flooring by flutes 10A and 10B to a diameter that is larger, e.g., by about 2 to 3 mm, than the maximum o.d. of the threaded section of the fastener. The wings are relatively thin, e.g., about 0.7 mm thick, being designed to be strong enough to cut into hard wood paneling as the screw is rotatively driven into and through the paneling, but weak enough to be sheared off as a result of the resistance to penetration offered by the steel or other metal substrate into which the screw is being driven.

The screw thread 12 commences at the rearward end of cutting flutes 10A and 10B, and preferably extends to where the head 6 joins the shaft. However, it is contemplated that screw thread 12 may terminate short of the head. Screw thread 12 has a triangular shape in cross-section, so that the thread has a sharp cutting edge whereby the fastener can cut into a metal substrate and provide a self-tapping function. The thread has a pitch angle in the range of about 57° to about 63°, preferably about 60°, and a flat root 20. The maximum diameter of screw portion 12 exceeds the maximum diameter of the forward drill portion of the shaft by approximately 1.2 mm, so that screw thread 12 can cut a screw thread in the hole formed in a metal structural member by drill portion 10. Since the wings project radially beyond the screw thread, they are able to cut a larger hole in the wood flooring or paneling through which the screw passes as it is being driven into an underlying metal substrate.

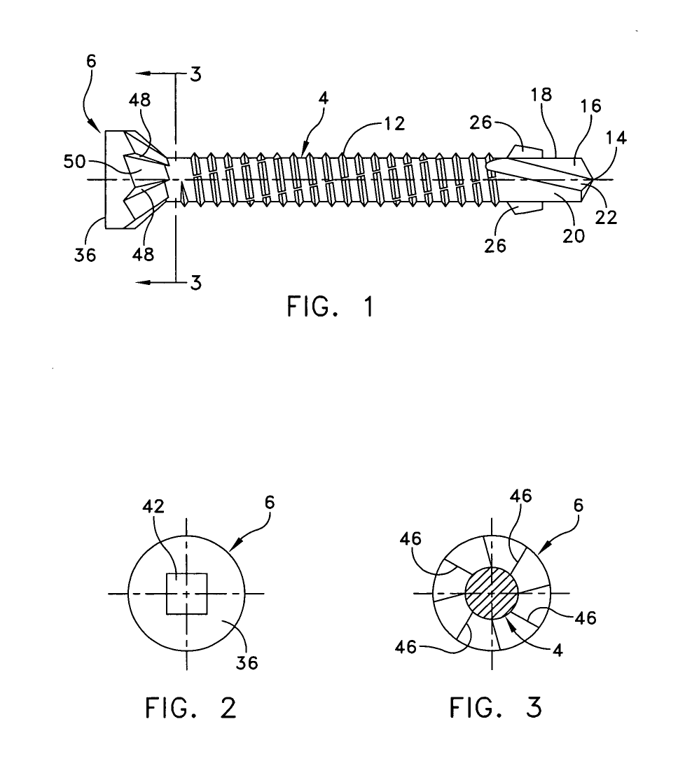

The head 6 is round and is formed with a flat circular top surface 36, a tapered bottom surface 38, and preferably, but not necessarily, a narrow cylindrical side surface 40. Top surface 36 is formed with a suitable recess for interlocking with a driver tool bit. Thus, for example, as illustrated in FIG. 2, the upper surface may be provided with a square recess 42 for receiving a square drive tool bit. Alternatively, the top surface 36 may have a recess of different shape for mating with a tool bit, e.g. a Torx® or six-lobe recess, as disclosed in my U.S. Pat. No. 6,676,353, cited supra.

The tapered surface 38 is formed with a plurality of cutting blade edges 46 (a total of eight cutting edges is preferred but not essential) which are spaced uniformly from one another about the circumference of tapered surface 38 and are defined by first and second flat relief sections 48 and 50. Each cutting edge 46 constitutes the corners formed by the intersection of the outer end of a first flat section 48 with the outer end of an adjacent second flat section 50. As shown in the drawings, each first flat relief section 48 has a smaller surface area than each flat relief section 50. Each cutting edge 46 extends down to the shaft 4. The plane of each flat relief section 48 extends along a chord of an imaginary circle that is coaxial with shank 4 and head 6, and also at an angle to the axis of the shank. The plane of each flat relief section 50 also extends along a chord of an imaginary circle that is coaxial with shank 4 and head 6, and also at an angle to the axis of the shank. Preferably each first relief section 48 intersects a second relief section 50 at an angle of approximately 90 degrees. The result of this geometrical design is that each second relief section 50 has a trapezoidal shape and each cutting edge 46 extends at an acute angle to the shank in two directions, being slanted top to bottom in the plane of FIGS. 1, 5 and 8 and also slanted outwardly of the plane of FIGS. 1, 5 and 8. Also, as shown in FIGS. 1 and 5, the first and second relief sections 48 and 50 form a zig-zag pattern in side elevation.

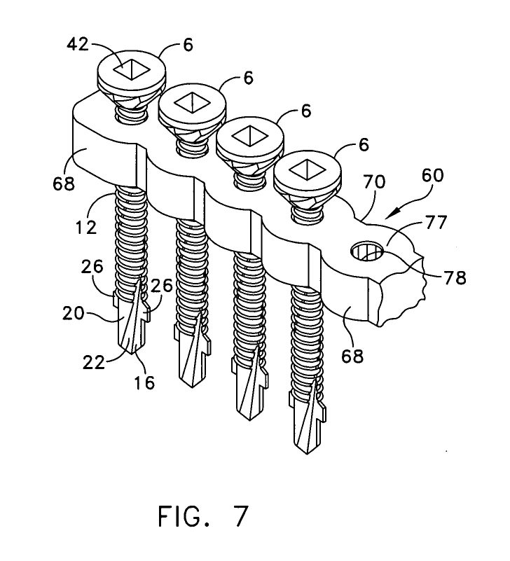

While the fasteners may be manually positioned one by one in driving relation with a screw driver, it is preferred to have the fasteners mounted in a plastic strip 60 and using them with a screw driver device (not shown) having a magazine that comprises means for holding a clip of fasteners, i.e., a plastic strip filled with fasteners as herein described and illustrated (FIGS. 7-9), and pusher means for advancing the clip so that each successive fastener in turn is located in position to be engaged by a tool bit attached to or forming part of the screw driver device and driven by that tool bit out of the plastic strip into structural components that are to be attached to one another. Such a magazine is described and illustrated in my U.S. Pat. No. 6,990,731, cited supra.

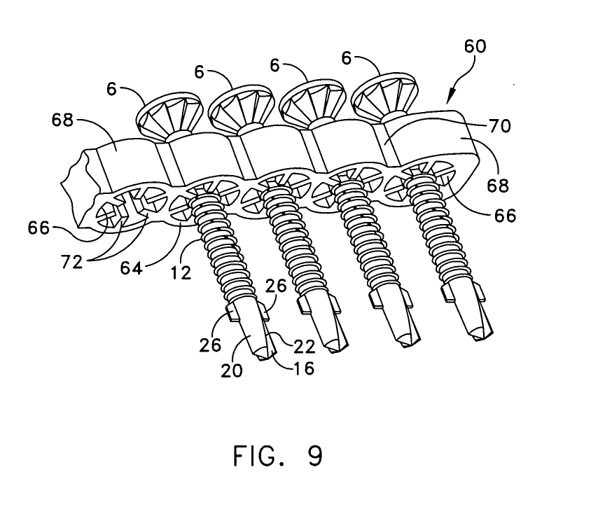

FIGS. 7-9 illustrate a clip comprising a plastic mounting strip 60 carrying a plurality of the above-described fasteners. The plastic strip has flat top and bottom surfaces 62 and 64, and a series of uniformly spaced circular through holes 66 (FIG. 9) for accommodating the fasteners that extend perpendicular to those flat top and bottom surfaces. Preferably, but not necessarily, the strip is injection molded of polyethylene, polypropylene or nylon and is of moderate density and flexibility. The plastic strip may have flat longitudinally-extending opposite side surfaces, but in the preferred embodiment of the invention the opposite side surfaces are contoured with circularly curved segments 68, creating the general impression of a plurality of sleeves connected in series with one another. Contouring the side surfaces as shown and described serves to reduce the amount of surface area of the strip that is contacted by the magazine in which it is supported in fastener-advancing relation to the associated fastener driver and also to reduce the amount of plastic consumed in making the strip. It is intended that the strip remain intact (except for the removal of certain fastener-gripping features) when a fastener is driven in the manner contemplated by this invention. Accordingly the reduced width portions 70 of the strip resulting from the contouring of the side surfaces may be relatively thick as shown so as to provide stability and assure that the strip will not rupture when the fasteners are impacted by the driver apparatus.

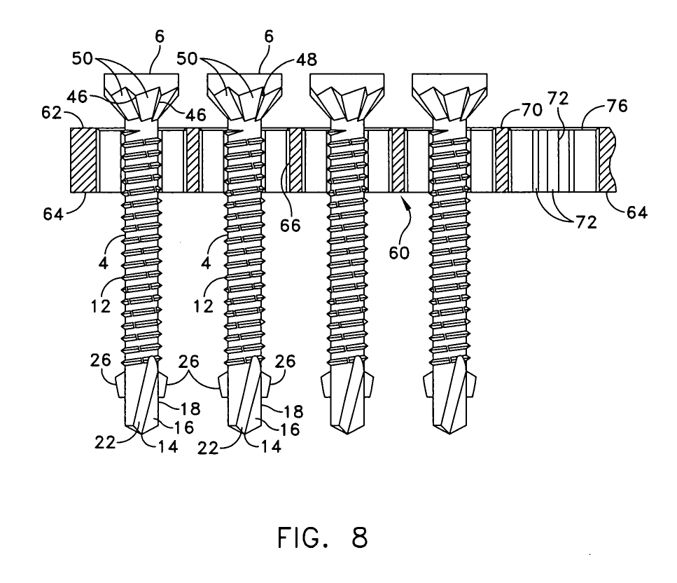

The holes 66 in strip 60 have a constant diameter, except for the presence of a plurality of radially-extending, uniformly spaced fastener-retaining ribs 72. Preferably, as shown in FIG. 8, the bottom ends of ribs 72 are flush with the bottom edge surfaces 64 of the strip, but the bottom edge surfaces of the ribs may be recessed slightly, e.g., about 1/16 inch, above the level of the bottom surfaces 64 without affecting operation of the invention. At their upper ends the ribs are connected by thin webs 76 that collectively coact with ribs 72 to form a top annular end wall 77 for the hole 66. The upper sides of webs 76 and the upper ends of ribs 72 are flush with the top surface 62 of strip 60. Ribs 72 and webs 76 have substantially identical radial dimensions, with their inner ends being curved to define a circular hole 78 (FIG. 7) having a diameter which is slightly smaller than the maximum diameter of the threaded portion of the fasteners, whereby to grip the fasteners.

In its preferred embodiment, each of the holes 66 is formed with six ribs 72 since that number of ribs has been found to be optimum in relation to providing the support required to keep the fastener aligned with the center axis of the hole and facilitating removal of the fastener from the strip. Problems in maintaining the fasteners axially aligned with the holes 66 have been encountered where only three or four fastener-retaining ribs were provided at each hole. Providing more than six ribs increases the resistance to removal of the fasteners from the plastic strip in the course of driving the fasteners into a multi-component workpiece, e.g., a wood flooring panel and a metal substrate.

The fasteners are mounted in holes 66 in plastic strip 40 so that their heads 6 are spaced from the upper end surface 62 of the strip, as shown in FIGS. 7-9. In this connection it is to be noted that the maximum outside diameter of each head 6 is less than the diameter of the hole 66 in which it is mounted, but larger than the diameter of the circular hole 78 formed by ribs 72 and webs 76. Ribs 72 and webs 76 grip the threaded portion of the fasteners and hold them in the plastic strip. Webs 76 are provided to assure that the fasteners are held perpendicular in holes 66. It has been determined from the use of plastic strips wherein the holes 66 had ribs 72 but not the webs 76 that when the fasteners are inserted by machine into holes 66, the wings 26 tend to cut away by abrasion a small portion of one or more ribs, thereby reducing the grip exerted by the ribs and resulting in the fasteners being somewhat loose rather than being held exactly perpendicular in the plastic strip. The existence of play between the fasteners and the strip may interfere with proper driving of the fasteners by the tool bit. The addition of webs 76 between ribs 72 increases the total surface area gripping the fasteners and thereby reduces the amount of “play” between the fasteners and the strip that supports them, even though one or both of the webs 76 may be torn by the wings 14 when the fasteners are inserted into the strip. The thickness of webs 76 is kept small to make it easier for the webs to yield rather than tear under the influence of wings 14 as the fasteners are inserted into the strip. Making webs 76 thin rather than thick also facilitates expelling of the fasteners from the plastic strip by operation of the driver tool. As noted previously, having the fastener-retaining ribs 72 and the webs 76 assures that the fasteners are axially aligned with holes 42 when they are advanced into driving position. Such alignment is important to facilitate rapid and reliable locking engagement of the driving tool bit with the recesses 42 in the heads of successive fasteners.

By way of example, but not limitation, strip 60 may have a maximum width (the width at the center of the curved segments 68) of about 0.650 inch, a width of about 0.510 inch at the reduced width portions 70, and a height of about 0.310 inch, holes 66 may have an i.d. of about 0.510 inch, ribs 72 may have a thickness of about 0.075 inch, webs 76 may have a thickness of about 0.010 inch, the circular hole 78 formed by the inner edges of ribs 72 and webs 76 may have a radius of about 0.225 inch, and the two wings 26 of each fastener are tangent to an imaginary circle having a diameter of about 0.060 inch greater than the maximum o.d. of the self tapping threaded section 22. Plastic strips having the foregoing shape and dimensions have been found to be suitable for reliably supporting screw fasteners of various lengths having a threaded section with a thread root o.d. of about 0.230 inch.

As noted above, the cutting flutes 10A and 10B provide each fastener with a self-drilling capability, while the screw thread 12 provides the fastener with a self-tapping capability. More particularly, if the fastener is driven into a workpiece consisting of, for example, a hard wood flooring member overlying a steel substrate, with the driving being conducted by an axially-biased power-driven rotating tool bit that rotates the fasteners clockwise in relation to the workpiece, the cutting flutes 10A and 10B will drill through the flooring member and the underlying substrate to form a starting hole, the wings 26 will widen the hole formed in the flooring member but break off when they encounter the steel substrate, and the leading turns of screw thread 12 will commence a tapping operation in the steel substrate, whereby continued rotation of the fastener under the influence of an applied axial force in the direction of the workpiece will cause the screw thread 12 to form a mating screw thread in the surrounding surface of the steel substrate that defines the starting holes formed by cutting flutes 10A and 10B.

The novel cutting blade edges 46 provide a cutting action that is superior to that of the cutting ribs of the screw fasteners described and claimed in my U.S. Pat. No. 6,676,353, cited supra. When a fastener as herein described is driven out of the strip 60 into a multi-component workpiece, e.g., a hard wood flooring member in the form of a flat panel and a steel substrate in the form of an I beam, the axial and rotational forces exerted on the fastener by the tool bit of the torque driver device will cause its cutting blade edges 46 to easily and rapidly chew away the retainer ribs 72 and webs 76 that surround and grip that fastener, with the removed pieces of ribs 72 passing out of the sleeve with the fastener. Also as each fastener is driven through a hard wood flooring member into an underlying metal substrate, the cutting blade edges 46 readily cut away portions of the hard wood flooring panel to form a countersink shaped to accommodate the head of the driven fastener, thereby permitting the upper surface of the fastener head to be flush with or slightly below the upper surface of the flooring, so that they cannot impede sliding movement of goods along the flooring unless and until the flooring becomes worn.

Tests have demonstrated that cutting edges 46 provided according to this invention do not burnish the hard wood flooring members as has occurred with screw fasteners of the type described and illustrated in my U.S. Pat. No. 6,676,353. The improved cutting action encourages the use of fasteners with larger diameter shanks and heads which provide the added benefit of greater holding power.

In addition to what is obvious from the foregoing specific description, further advantages of the invention are that the fasteners can be removed by an unscrewing action and may be manufactured using conventional screw-manufacturing apparatus. A further advantage is that the screws may be made in different size lengths and diameters. The plastic strips 60 also may be made in different lengths to accommodate a selected number of fasteners. Of course, the fasteners may be applied by means of a powered screw driver even if they do not form part of a clip of fasteners as herein described or are not fed from a magazine. The fasteners herein described and claimed also could be used with a different form of plastic support strip and screw driver apparatus other than the one described and claimed in my U.S. Pat. No. 6,990,731, e.g., the drivers disclosed in U.S. Pat. No. 5,862,724 issued to Ken Arata et al., U.S. Pat. No. 4,625,597 issued to Adolf Cast, and U.S. Pat. No. 6,062,113, issued to Yoshihiro Nakano et al.

While not necessary, having the fasteners positioned with their heads elevated above the upper side of the plastic strip is preferred for two reasons: (1) it allows the screws to achieve a relatively high rotational speed before the cutting blade edges ribs 46 engage the plastic retaining ribs 72, thereby facilitating rapid cutting away of those ribs; and (2) having the screw heads elevated permits the screw heads to be guided by opposite side wall portions of the feeder magazine, thereby helping to keep the fasteners in the alignment required by the powered screw driver.

It is to be appreciated that certain changes may be made without departing from the essence of the invention. For one thing, the side surfaces 40 of the fastener heads may vary in height; they even may be totally eliminated in the sense that bottom surface 38 can be extended so as to intersect top surface 36. Further by way of example, the slope of bottom surface 38 and the cutting blade edges 46 may be changed relative to the fastener shaft, and relative sizes of relief sections 48 and 50 also may be varied. The recess 42 could be replaced with recesses shaped to receive and mate with a Phillips-type screwdriver bit, or a tool bit of other end configuration. Another possible modification is to form the fastener with more than two cutting flutes.

A further possible change is to replace strip 60 with a plastic strip that has straight and flat opposite external side surfaces in place of the curved external configuration shown in the drawings. That alternative strip would still have a series of openings with ribs like ribs 72 to support the fasteners in the manner described herein, and would function in the same manner as the strip 60. However, it suffers from the disadvantage of requiring more plastic material. It also is contemplated that the fasteners are not limited in use to attaching wood flooring panels to metal substrates. By way of example, the fasteners could be used to attach plastic or aluminum members to a steel substrate or to attach metal decking to a steel substrate. Still other changes and advantages of the invention will be obvious to persons skilled in the art from the foregoing description and the attached drawings.

What is claimed is:

1. A fastener for use in attaching wood panels to a metal substrate, said fastener comprising a shank and a head at a first end of said shank:
said shank having a tapered point at a second opposite end thereof, cutting flutes that extend along said shank from said tapered point and a helical thread extending between said flutes and said head; and
said head having a top surface and a tapered surface extending away from said top surface toward said shank, said top surface having means adapted for engagement by a driving tool for rotating said fastener in a direction to cause said thread to screw into a substrate, and said tapered surface having a series of circumferentially spaced cutting edges that function as cutting blades when the fastener is rotated on its own longitudinal axis, said cutting edges each having a first bottom end and a second top end that is displaced in a circumferential direction from said first bottom end and being defined by a first relief section in said side surface that extends at a first angle to said shank and a second relief section in said side surface that intersect said first relief section and extends at a second acute angle to said shank.

2. A fastener according to claim 1 wherein said second relief sections intersect said first relief sections at an angle of approximately 90 degrees.

3. A fastener according to claim 1 wherein each of said first relief sections extends along a chord of a circle that is coaxial with said shank.

4. A fastener according to claim 1 wherein second relief section extends along a chord of a circle that is coaxial with said shank.

5. A fastener according to claim 1 wherein said cutting edges are formed by the intersection of said first and second relief sections of said side surface and said second relief sections have a trapezoidal shape.

6. A fastener according to claim 1 wherein said tapered surface extends from said shank to said top surface.

7. A fastener according to claim 1 wherein said head has a recess adapted to be operatively engaged by a tool for screwing and unscrewing said fastener.

8. A fastener according to claim 1 wherein said head comprises a cylindrical outer surface that extends between said top end surface and said tapered surface.

9. A fastener according to claim 1 wherein said first relief sections have a smaller surface area than said second relief sections.

10. A fastener according to claim 1 wherein at the periphery of said head said first and second relief sections form a zig-zag pattern in side elevation.

11. A clip of fasteners for use in securing together two superimposed structural components, said clip comprising:
an elongate plastic strip comprising a top surface, a bottom surface, a series of mutually spaced openings aligned lengthwise of said strip, and a plurality of fastener-gripping ribs extending inwardly of each of said openings; and
a series of fasteners as defined in claim 1, with each of said fasteners mounted in one of said openings substantially perpendicular to said top and bottom surfaces.

12. A clip of fasteners for use in securing together two superimposed structural components, said clip comprising:
a plastic strip having lengthwise extending top and bottom surfaces and two opposite side surfaces, a series of mutually aligned holes in the strip with each hole extending perpendicular to and between said top and bottom surfaces, each hole having a plurality of inwardly extending fastener-gripping ribs and a web between each rib formed integral with said top surface, said ribs and said webs having inner portions that are aligned to define a circular opening, and
a series of fasteners each mounted in one of said holes, each of said fasteners comprising a shank having a tapered point at one end thereof and a head at a second opposite end thereof, said shank also having a drill portion comprising cutting flutes that extend toward said head from said tapered point and a screw portion comprising a helical thread that extends from adjacent said flutes to adjacent said head and is gripped by said fastener-gripping ribs, and said head extending outwardly beyond the periphery of said shank and having a top surface and a tapered surface, said top surface having means adapted for engagement by a driving tool for rotating said fastener in a direction to cause said drill portion to drill a hole in a workpiece and said threaded portion to screw into said substrate, and said tapered surface having a plurality of circumferentially spaced cutting edges that function as cutting blades for cutting through at least said fastener-gripping ribs of the hole in which is gripped when the fastener is rotated on its own longitudinal axis and driven downward relative to said plastic strip, said cutting edges extending at an acute angle to said shank in a first direction and also in a second direction.

13. A clip of fasteners according to claim 12 wherein each of said cutting edges is defined by a first relief section in said side surface that extends at a first angle to said shank and a second relief section in said side surface that intersect said first relief section and extends at a second acute angle to said shank.

14. A clip of fasteners according to claim 13 wherein said tapered surface consists of said first and second relief sections that intersect one another.

15. A clip of fasteners according to claim 13 wherein each of said first relief sections extends along a chord of a circle that is coaxial with said shank.

16. A clip of fasteners according to claim 15 wherein each of said second relief section extends along a chord of a circle that is coaxial with said shank.

17. A clip of fasteners according to claim 13 wherein said cutting edges are formed by the intersection of said first and second relief sections of said side surface and said second relief sections have a trapezoidal shape.

18. A clip of fasteners according to claim 12 wherein said cutting edges of each fastener extend to and join the outer surface of the shank of said each fastener.

19. A clip of fasteners according to claim 12 wherein each fastener comprises a least a pair of cutting wings projecting from said drill portion adjacent said screw portion.

20. A fastener clip for use in supplying fasteners to a driver tool, said clip comprising:
an elongate plastic strip comprising a top surface, a bottom surface, a series of mutually spaced openings aligned lengthwise of said strip, and a plurality of fastener-gripping ribs extending inwardly of each of said openings; and
a series of fasteners each mounted in one of said openings, each of said fasteners comprising a shank having a tapered point at one end thereof and a head at a second opposite end thereof, said shank also having a pair of cutting flutes that extend from said tapered point and a helical thread extending from adjacent said flutes to adjacent said head, and said head extending outwardly beyond the periphery of said shank and having a top surface and a tapered bottom surface, said top surface having means adapted for engagement by a driving tool for rotating said fastener in a direction to cause said thread to screw into a substrate, and said tapered bottom surface having a series of circumferentially spaced cutting edges for cutting through at least said fastener-gripping ribs of the sleeve in which is gripped when the fastener is rotated on its own longitudinal axis and driven downward relative to said plastic strip, said cutting edges extending at an acute angle to said shank in a first direction and also in a second direction.

21. A fastener clip according to claim 20 wherein said cutting edges are defined by a plurality of first and second relief sections, each first relief section extending at a first angle to said shank and each second relief section extending at a second acute angle to said shank and intersecting an adjacent first relief section to form one of said cutting edges.

22. A clip according to claim 21 wherein said tapered surface consists of said first and second relief sections disposed in alternately-occurring relationship with one another,
